(19) United States
(12) Patent Application Publication
(10) Pub. No.: US 2009/0078011 A1
(43) Pub. Date: Mar. 26, 2009

(54) Mortise Lock

(76) Inventor: Ben-Zion Avni, Kfar Saba (IL)

Correspondence Address: THE NATH LAW GROUP, 112 South West Street, Alexandria, VA, 22314, US

(21) Appl. No.: 11/922,893

(22) PCT Filed: Jun. 27, 2006
(86) PCT No.: PCT/IL2006/000746

§ 371 Date: Jan. 23, 2008

Related U.S. Application Data
(60) Provisional application No. 60/693,883, filed on Jun. 27, 2005.

(51) Int. Cl. E05B 63/08

(52) U.S. Cl. 70/486

(57) ABSTRACT

A mortise lock comprising a housing, a locking mechanism, a locking latch and one or more bolts displaceable between a locked position and an unlocked position; the locking mechanism fitted with a lock cylinder, a handle assembly comprising an inside locking latch activator articulated with the locking latch and the bolts and an independent outside locking latch activator articulated only with the locking latch, a locking latch sensor for selectively arresting the locking latch, and a deadbolt mechanism for arresting the bolts at their extended, locked position.

### FIELD AND OF THE INVENTION

The present invention is concerned with a mortise lock and more particularly it is concerned with such a mortise lock fitted with multiple locking bolts, the lock being actuated in different operable positions.

### BACKGROUND OF THE INVENTION

Mortise locks are well known in the art and are typically designed to fit into an opening formed at the locking stile (an edge of a door opposite the edge that is hinged to the door frame).

A mortise lock generally includes one or more latches (also referred to as bolts) displaceable between an extended position in which they project beyond the edge of the door into a corresponding opening in the door frame (and/or wall or sealing/floor, in some cases) so as to latch the door closed, and a retracted position in which opening of the door is facilitated.

Also known in the art are so called “panic doors” which are designed so as to quickly be opened, from the inside, at different emergency situations no matter if the door is locked or not, typically by simply actuating a door handle or bar. This requirement is to enable fast escape from an enclosure (building and the like) in case of emergency.

A large diversity of mortise locks are known in the art, designed to provide different operable situations of the locking mechanism. Examples of mortise locks are disclosed in U.S. Pat. Nos. 4,154,070 and 5,678,870 and in WO 99/61734 and WO 2004/059114.

### SUMMARY OF THE INVENTION

According to the present invention there is provided a mortise lock comprising a mortise lock case housing, a locking mechanism, a locking latch and one or more bolts displaceable between a locked position and an unlocked position; the locking mechanism fittable with a lock cylinder, a handle assembly comprising an inside locking latch activator (‘inside nut’) articulated with the locking latch and the bolts and an independent outside locking latch activator (‘outside nut’) articulated only with the locking latch; a locking latch sensor for selectively arresting the locking latch, and a deadbolt mechanism for locking the bolts at their extended, locked position.

As can be appreciated, the lock cylinder may be key-operated, electrically operated, or otherwise.

According to one embodiment of the invention, the lock is a multi-functional lock and is fitted with a panic selector for selectively engaging the inside handle with the bolts regardless of whether or not the bolts are locked by the lock cylinder, and a handle selector for selectively engaging the outside handle with locking latch.

According to another particular embodiment of the invention the handle assembly comprises a handle selector mechanism comprising in turn an inside locking latch activator operable by the inside handle, and a bolt activator selectively engageable with said inside locking latch activator by the panic selector, and a separable outside locking latch activator selectively engageable with the outside handle by a handle selector knob.

The design may be such that the inside locking latch activator and the outside locking latch activator are coaxial or axially shifted, however, they are functionally separated from one another and also comprise, according to a particular aspect of the invention a security plate rotatably fitted there between to prevent tampering from the outside.

However, according to another embodiment of the invention, the mortise lock is fitted with an active panic mechanism for unlocking and unlocking the lock (and opening the door) from the inside, regardless the locking state of the lock. Namely, depressing the inside handle will result in immediate unlocking of the lock (locking latch and all bolts), regardless the locking state of the lock.

The following are some particular aspects and embodiments or modifications of the mortise lock according to the present invention, referring to either or both of the embodiments:

the locking latch sensor is fitted for cooperation in conjunction with a lock jamb supporting a door fitted with the lock, for arresting the locking latch and retaining it at its retracted position when the door is opened; however closing the door entails depressing the locking latch sensor, resulting in that the locking latch will return to its locked, projecting position;

the locking latch sensor comprises a spring biased plunger for axially projecting from the front plate of the lock and formed with a cam surface followed by a spring biased locking arm designed to engage with the locking latch and arrest it at its retracted position when said plunger projects from the front panel;

the outside locking latch activator is selectively engageable with the outside handle via a coupling member fixed with the outside handle. Normally the outside handle is retained at its un-depressed position, owing to a biasing spring;

applying to the first embodiment, the coupling member is biased to retain the outside handle at its closed position. When the outside locking latch activator is disengaged from the outside handle it is lockingly engaged with a casing of the handle selector mechanism;

applying to the first embodiment, either one or both of the panic selector and the handle selector knob is fitted on a front plate of the lock or on an inside plate thereof;

applying to the first embodiment, when the inside locking latch activator is disengaged from the bolt activator, it is lockingly engaged with a casing of the handle selector mechanism;

applying to the first embodiment, the panic selector and the handle selector are displaceable between discrete positions;

applying to the first embodiment, the inside handle is articulated with the locking latch by a bell crank, such that once the inside handle is depressed it will remain at its depressed position if the door is open, and the inside handle will return to its non depressed position upon closing the door;

the bolts comprise one or more face bolts extendable from the front plate of the mortise lock case housing and being displaceable along a first axis (typically horizontal, though not restricted to such a configuration); and one or more secondary bolts projecting from the case housing and being restricted for displaceable about a second axis substantially perpendicular to said first axis (typically vertical). Often there is further provided a rear bolt displaceable about an axis parallel to said first axis, though at an opposite sense, so as to project through a hanging stile of the door; it is however appreciated that the secondary bolts may be displaceable about axes not necessarily perpendicular to the first axis.

the locking latch and optional one or more face bolts projecting from the front plate of the mortise lock case housing, symmetrically extend the front plate of the lock and/or at a locking stile of a door fitted with a lock according to the invention;

a static bolt may be provided, fixedly extending from the lock case housing through a hinge stile of a door for engagement with a corresponding aperture formed at a door jamb;

the one or more face bolts are articulated to a locking plate displaceable between a respective locked and an unlocked position, retractable either by the lock cylinder or by the inside handle, said locking plate being restricted into axial displaceable in a plane along the first axis;

according to one particular design applying to the first embodiment, the secondary bolts are each articulated to the locking plate by a link converting linear motion from said first axis into said second axis; by another particular design, the secondary bolts are articulated to the locking plate by a gear train, each bolt being fitted with a link for converting motion between said first axis and said second axis;

according to another design the front bolts, the secondary bolts and the rear bolt are each articulated to a locking cog by a link converting rotary motion into linear displacement, whereby rotating the locking cog in one direction entails retraction of all bolts and rotating the locking cog in an opposite direction entails projection of the bolts;

an additional bolt may be fitted for axial displacement in a plane substantially parallel to said first axis, though in an opposite sense;

applying to the first embodiment, the deadbolt mechanism comprises a locking block fixed within the mortise lock case, a bridge member fixedly attached to the face bolts and being articulated to the locking plate with limited degree of freedom along the first axis, a locking piece articulated to the locking plate and having limited degree of freedom along the second axis; said locking piece being articulated to the bridge member by a motion converting mechanism such that axial displacement of the bridge member about said first axis entails corresponding axial displacement of the locking piece about said second axis, whereby when the face bolts are at their extended, locked position, the locking piece is lockingly engaged with the locking block, and where retracting the face bolts entails disengagement of the locking piece from the locking block;

With respect to the first design of the deadbolt mechanism, the following may apply;

the motion converting mechanism is in the form of an engagement member projecting from one of the bridge member and the locking piece, and an inclined slot formed in the other of said bridge member and the locking piece and slidingly receiving said engagement member;

the locking block is formed with a gliding surface and an arresting shoulder, and the locking piece is formed with a sliding portion formed with a locking edge, wherein when at the locked position of the face bolts the locking edge is arrested by the arresting shoulder; and during displacement of the face bolts between a retracted, open position, and an extended, locked position, the sliding portion smoothly slides over said gliding surface;

the locking piece is articulated to the locking plate by an engagement member projecting from one of the locking plate and the locking piece, and a slot extending along said second axis, formed in the other of said locking plate and the locking piece and slidingly receiving said engagement member;

the bridge member is articulated to the locking plate by an engagement member projecting from one of the locking plate and the bridge member, and a slot extending along said first axis, formed in the other of said locking plate and the bridge member and slidingly receiving said engagement member;

according to a second design of the deadbolt mechanism a locking piece is restricted for axial displacement about the second axis between an upward, biased position and a downward position; the locking plate is formed with an abutting shoulder for abutting against a corresponding shoulder of the locking piece such as to prevent displacement of the locking plate, namely to prevent retraction of the face bolts.

according to a specific design the locking piece is displaced downward by a connecting lever pivotally coupled to the locking cog. Alternatively, the locking piece is displaced by a cam of a cylinder engaging gear wheel which in turn is engaged with the lock cylinder.

the locking mechanism comprises, according to an other embodiment thereof, the cylinder engaging gear wheel engageable with the lock cylinder and in turn engaged with a geared locking cog, to which the secondary and rear bolts are linked, each by a pivotable link.

the arrangement is such that the links of the secondary bolts are pivotally secured to the locking cog along a first coupling axis extending through a center of the cog; and the connecting lever and rear bolt are pivotally secured to the locking cog about a second coupling axis transversing said first coupling axis at the center of said locking cog, at a right angle.

the links of the secondary bolts and the connecting lever and rear bolt are pivoted to the locking cog such that at the locked position each pair extends beyond the over-center position, respectively, such that axial force applied on any on any of the bolts, in a retraction direction, results in geometric locking of the locking cog, namely arresting it at the locked position where the bolts project, so as to prevent forced retraction of the bolts.

the cylinder engaging gear wheel is engaged with the locking cog which in turn is engaged with a third gear articulated with the inside locking latch activator, such that manipulation of the inside locking latch activator (that is possible only by the inside handle) entails corresponding rotation of the third gear, which in turn rotates the locking cog and the cylinder engaging gear, and the thereby rotating, resulting in simultaneous retraction of the locking latch and all the bolts (face bolts, secondary bolts and the rear bolt).

the cylinder engaging gear wheel is coupled with the locking latch sensor by a pivotable arm, such that rotation of the cylinder engaging gear wheel by the cylinder lock at an extent after the bolts have been retracted (e.g. at about 30°), entails retraction of the locking latch;

the locking latch has a rectangular cross-section, whereby it is unlikely to be manipulated from the outside e.g. by a card, screwdriver and the like.

the one or more secondary bolts are fitted for either/and projecting through a top and/or bottom rail of a door and for activating one or more auxiliary locking assemblies at lock stile of the door;

applying to the first embodiment, the inside handle is permanently engaged with the locking latch and the outside handle is permanently disengaged from the one or more bolts; and wherein when the panic selector is activated the inside handle engages with the bolts and when the handle selector is activated the outside handle is engaged with the locking latch;

applying to the first embodiment, the locking plate is articulated by a crank lever to the bolt activator, whereby depressing the inside handle, when the panic selector is activated to engage the inside handle with bolts, result in axial displacement of the locking plate about said first axis; however according to the second embodiment axial displacement of the locking plate about said first axis will take place at any event;

applying to the first embodiment, the locking plate is fitted with a locking gear engaged to an actuating gear of the lock cylinder, and further there is provided a crank link coupling said locking gear with the locking plate, whereby rotating the lock cylinder entails axial displacement of the locking plate about said first axis;

rotating the lock cylinder beyond 360° entails retraction of the locking latch by a pivot lever articulated at one end with the locking latch and at an opposed end it is formed with a follower arm for engagement with a cam projection formed on the locking gear;

the crank link is pivotally articulated to the locking plate, with a degree of freedom along the first axis, such that the face bolts do not retract beyond the front plate even when the lock cylinder is rotated more then 360°;

the locking plate is restricted for axial displacement about said first axis by one or more axial follower pins received with corresponding grooves formed correspondingly in the lock case and the locking plate;

the locking plate is displaceable between discrete positions corresponding with respective locked and unlocked positions of the lock;

restricting displacement of either the secondary and rear bolts in a particular axial direction may be facilitated by tracks integrally formed or attached to at least one face covers of the mortise lock case housing;

the invention calls for a mortise lock comprising a casing accommodating a handle assembly, a locking latch articulated to the handle assembly and to a locking latch sensor, one or more bolts manipulable by a locking plate and being displaceable between an open position and a locked position, and a deadbolt mechanism for locking face bolts extending from said locking plate at their extended, locked position, and wherein when the lock is at a fully locked position, namely the locking latch an all bolts are at their projecting position, manipulation of the inside handle results in immediate and synchronized unlocking of the lock, namely simultaneous retraction of the locking latch and all the associated bolts. However, an attempt to open the lock at this position using the outside handle entails only retraction of the locking latch. When the lock is at the so called slammed position, namely only the locking latch lockingly projects, whilst all the bolts are retracted, manipulation of either the inside handle or the outside handle equally results in retraction of the locking latch into its open position.

The invention is also concerned with a door fitted with a mortise lock according to the invention.

### BRIEF DESCRIPTION OF THE DRAWINGS

For better understanding the invention and to see how it may be carried out in practice, several embodiments will now be illustrated, by way of non-limiting examples only, with reference to the accompanying drawings, in which:

FIG. 1 is a partial view of a door front fitted with a mortise lock according to the present invention;

FIG. 2 is an isometric, partially exploded view of a portion of the door with the lock seen in FIG. 1;

FIGS. 3A and 3B are isometric views of an inside and an outside shield plate and handle, respectively of the lock seen in FIGS. 1 and 2;

FIG. 4 is an isometric view of the lock according to the present invention, fitted with auxiliary locking assemblies;

FIG. 5 is an exploded isomeric view of a mortise lock according to an embodiment of the present invention, with a cover plate removed for visualization;

FIG. 6 is an exploded isomeric view of the mortise lock of FIG. 5, showing the cover plate, a cam support plate, and some other components;

FIG. 7 is a planer view of the lock, with the cover plate removed, at a fully locked position;

FIG. 8 is a planer view of the lock, with the cover plate removed, at a first step of unlocking the lock using the inside handle;

FIG. 9 is a planer view of the lock, with the cover plate removed, at an unlocked position of the bolts, using the cylinder lock, the locking latch still at its projecting position;

FIG. 10 is a planer view of the lock, with the cover plate removed, at a fully unlocked position using the inside handle and with the locking latch sensor at its projecting position;

FIG. 11 is a planer view of the lock, with the cover plate removed, at a fully unlocked position using the cylinder lock, and with the locking latch sensor at its projecting position;

FIG. 12 is an isometric view of the lock in the position of FIG. 11.

FIG. 13 is a front view of the mortise lock according to another embodiment of the present invention, fitted with a panic selector and a handle selector, the locking latch and bolts at their extended, locked position;

FIG. 14 is an inside view of the mortise lock of FIG. 13, though being an isometric view and with the lock cover removed;

FIG. 15A is an isometric view of a locking mechanism in accordance with an embodiment of the present invention;

FIG. 15B is an exploded isometric view of the locking mechanism taken along line C-C in FIG. 15A;

FIG. 15C is a planar partial section of the locking mechanism seen in FIG. 15A;

FIG. 16A is a planar view of principal components of the locking mechanism with the panic selector at its deactivated position;

FIG. 16B is a planar view of principal components of the locking mechanism with the panic selector at its activated position;

FIG. 17A is a planar view of principal component of the locking mechanism with the selector coupler at its disengaged position;

FIG. 17B is a planar view of principal component of the locking mechanism with the selector coupler at its engaged position;

FIGS. 18A and 18B are an enlargement of the portion marked X in FIG. 1, illustrating the panic selector in its activated and deactivated position, respectively;

FIG. 19 is a planar view of the lock of FIG. 14, illustrating retracting of the locking latch using the inside handle, with the bolts, a priori retracted;

FIG. 20 is an isometric view illustrating retraction of the locking latch to its unlocked position, and with the door still shut preventing projection of a locking latch sensor;

FIGS. 21A and 21B are planer views of the lock showing the latch retraction mechanism in an extended and a retracted position;

FIGS. 22A and 22B are enlargements of portion marked XVA and XVB, in FIGS. 21A and 21B, respectively;

FIG. 23 is a rear isometric view of the locking latch retracting mechanism;

FIGS. 24A through 24D are rear views of consecutive positions of a deadbolt mechanism associated with the face bolts during gradual extraction of the bolts; and

FIG. 25A through FIG. 25C illustrate an isometric enlargement of the deadbolt mechanism during consecutive steps of extension of the bolts;

### DETAILED DESCRIPTION OF THE INVENTION

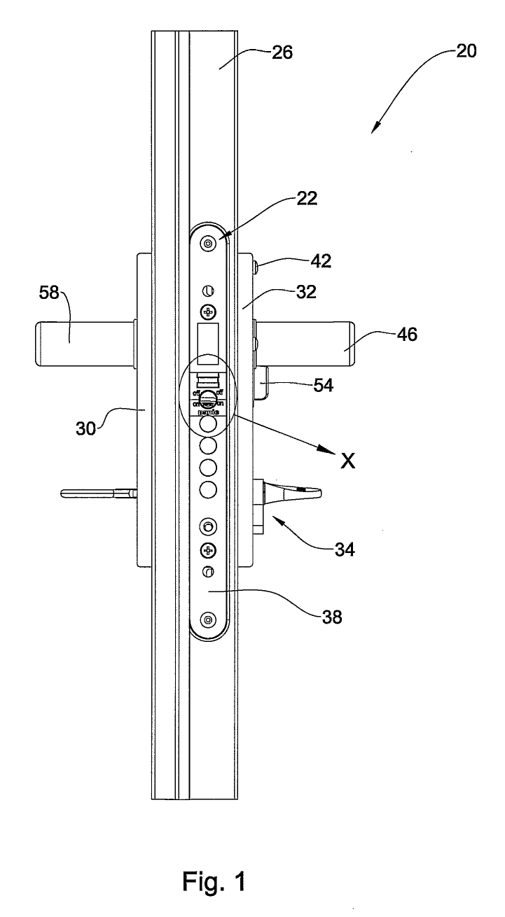

Attention is first directed to FIGS. 1 to 3 of the drawings illustrating a door 20 fitted with a mortise lock in accordance with the present invention generally designated 22, through an opening 24 formed at a locking style 26 of the door 20. The mortise lock assembly comprises an outside handle assembly 30, an inside handle assembly 32 and a cylinder lock 34. The arrangement is such, that at the assembled position, the lock is received such that a front plate thereof 38 extends substantially flush with the locking style 26 of the door, as seen in FIG. 1, with the inside plate and outside plate being interconnected to one another via so called blind bolts 40 extending from the outside plate 30 and being lockingly secured to bolts 42 fitted on the inside plate 32, whereby disengagement thereof may be facilitated only from the inside.

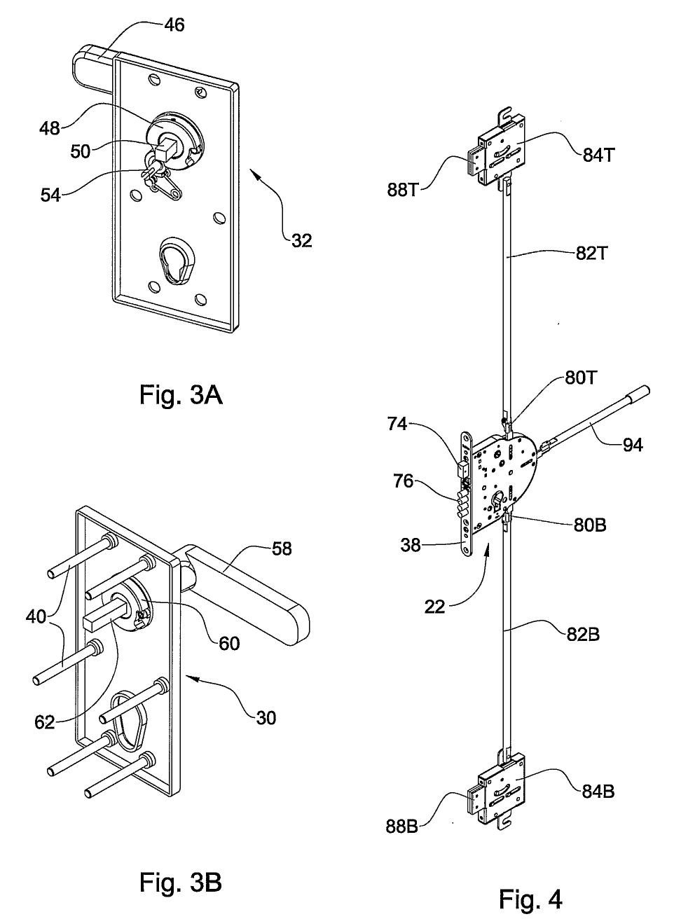

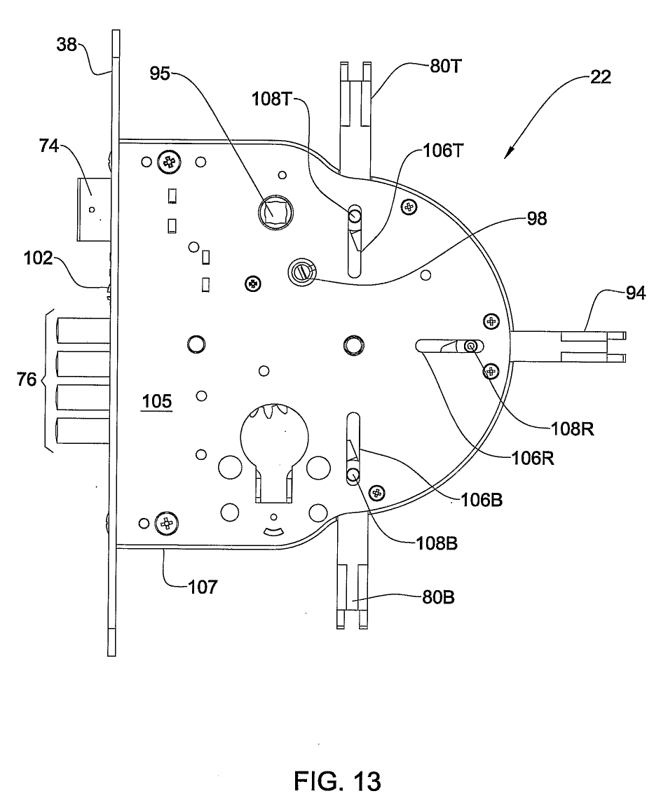

As can be seen in FIG. 3A, the inside plate 32 rotatably secures an inside handle 46 secured to the inside plate 32 by a nut 48 with an inside door handle square spindle 50 projecting therefrom. According to a different embodiment, the inside plate 32 further accommodates a handle selector 54, to which reference will be made in more detail hereinafter with particular reference to FIG. 13 and onwards.

In FIG. 3B there is illustrated the outside door plate 30 rotatably accommodating the outside handle 58 rotatably secured thereto by nut 60 and where a square spindle 62 inwardly projects.

At the assembled position (e.g. FIG. 1) both square spindles 50 and 62 coaxially engage a locking mechanism of the lock, though operable independently, as will be explained hereinafter in detail.

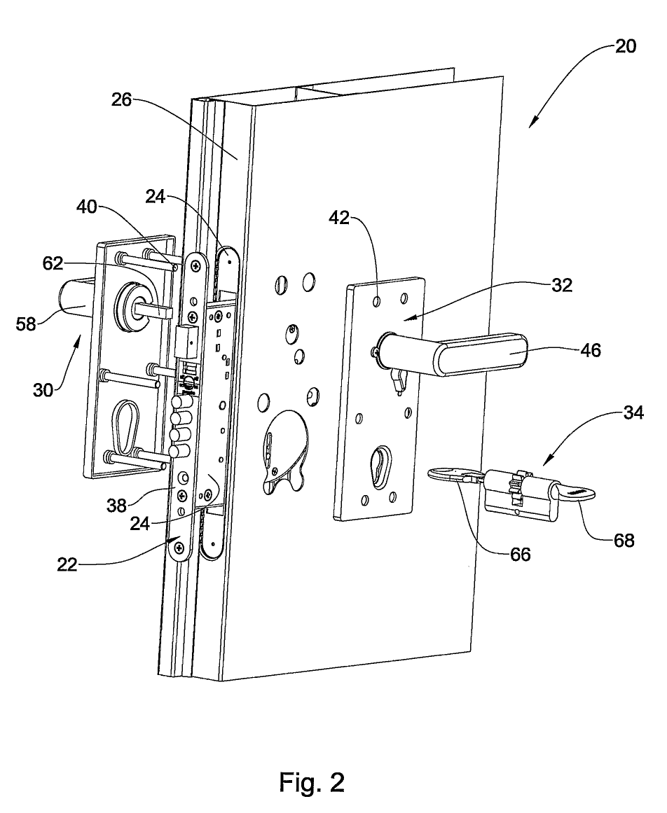

The cylinder lock 34 noticed in FIGS. 1 and 2 is fitted with a removable outside key 66 and a fixed inside knob 68. The inside knob 68 may be replaceable by a removable key, as known, per se, however, this is not preferable since in the case of a removable key the panic mechanism works only when the key is received within the cylinder lock. The option of a removable key will require that the user to first insert the key into the lock and only then open the door, thus loosing valuable time during emergencies.

In the illustration of FIG. 4, the mortise lock 22 is illustrated separate from the door wherein it is noticeable that its front plate 38 slidingly accommodates a locking latch 74, a plurality of face bolts 76, and two secondary bolts, namely a top bolt 80T and a bottom bolt 80B, each articulated via an extension rod 82T and 82B, respectively, to an auxiliary lock 84T and 84B, respectively. Auxiliary locks 84T and 84B are designed for locking engagement at the locking style of the door thereby provided with a locking latch 88T and 88B and optionally for projecting through a top and bottom rail of the door (not shown). Lock 22 further comprises a rearward extending static bolt 94 extending from the lock case and projecting through an opening formed at a hinge style of the door (not shown) for engagement with a corresponding aperture formed at a door jam (not shown) upon closing of the door.

It is also noticed in FIG. 1 that the locking latch 74 and the face bolts 76 extend substantially symmetrically within the front face of the door whereby it may be easily fitted within a “left side door” or a “right-side door”.

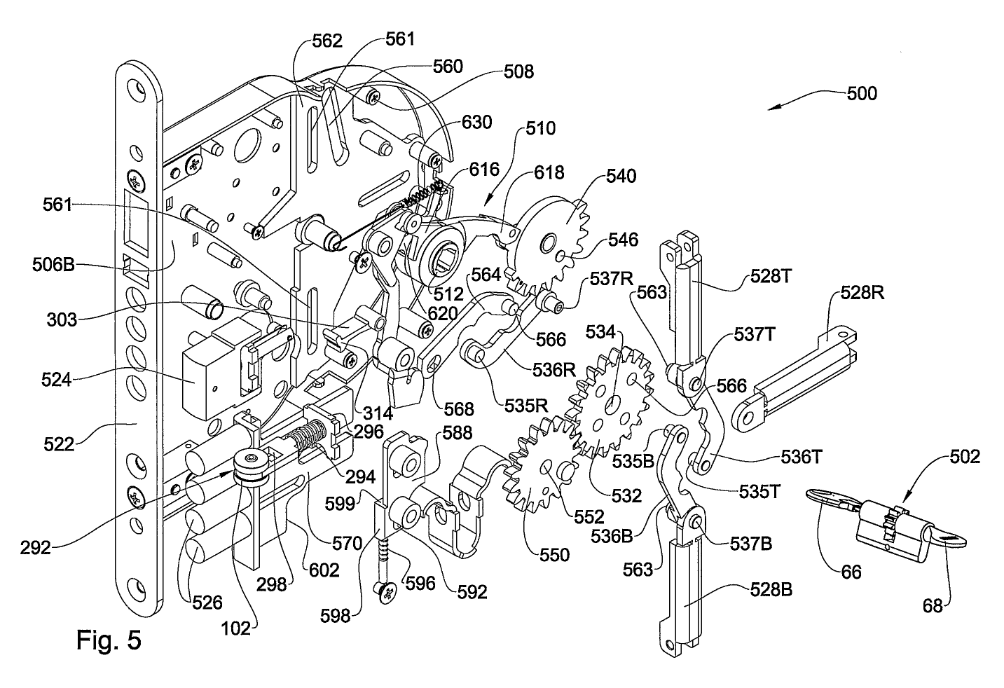

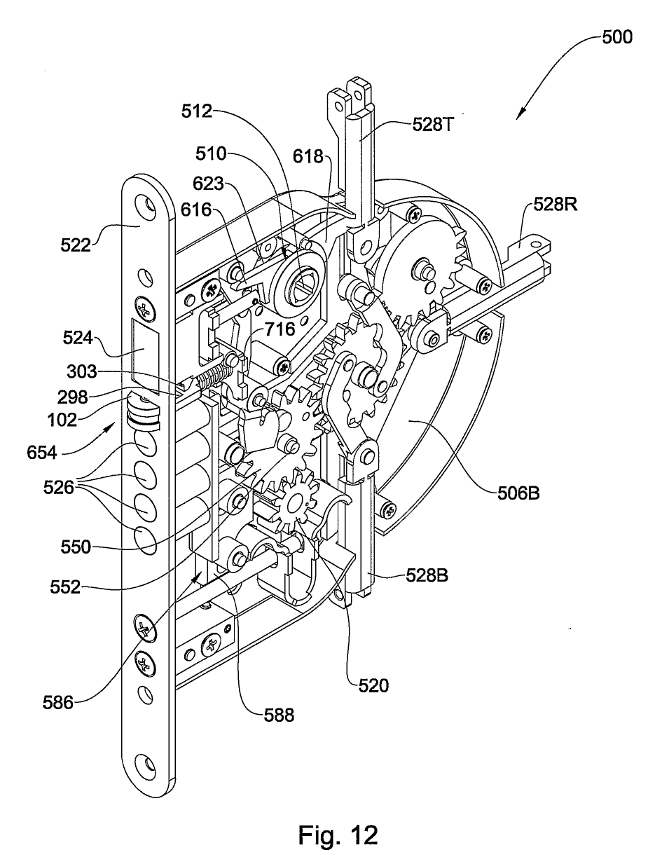

Turning now to FIGS. 5 to 12 there is illustrated a mortise lock according to one embodiment of the present invention, directed to an application without a panic selector and without a handle selector mechanism.

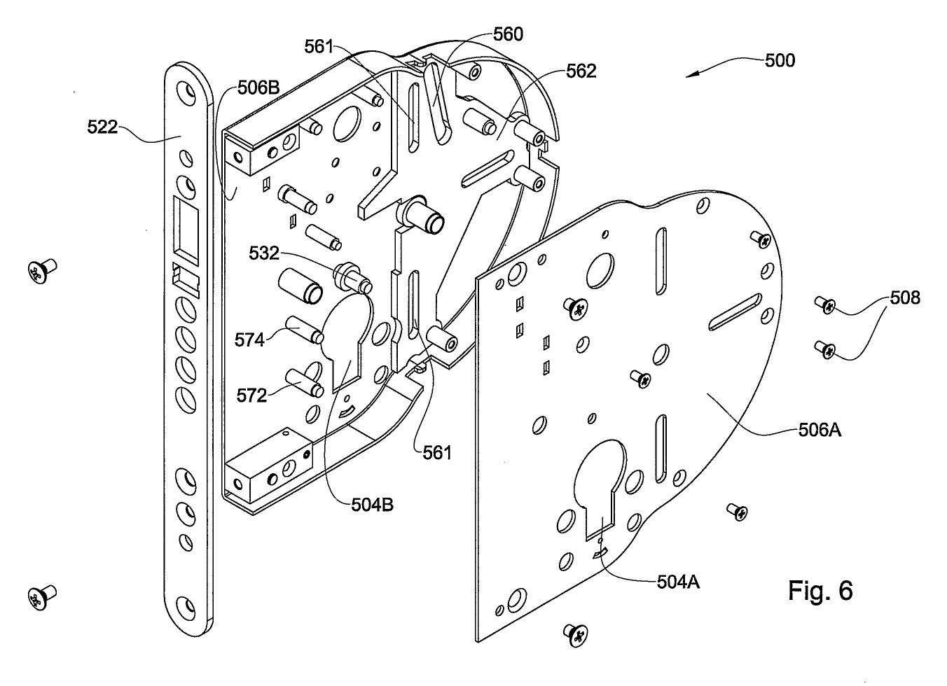

The lock in accordance with the second embodiment is generally designated 500 and is fitted for securely receiving therein a cylinder lock 502 (34 in FIGS. 1 and 2) through suitable openings 504A and 504B formed in the inside plate 506A and the outside plate 506B respectively, as shown in FIG. 5. The outside plate 506B is formed with side walls thus constituting a casing for the locking, whilst the inside face 506A serves as a cover securely attachable to the outside case 506B by means of bolts 508, as seen in FIG. 6.

The lock in accordance with the illustrated embodiment comprises a locking mechanism generally designated 510 which in the particular embodiment has a square receptacle 512 for receiving a corresponding square spindle 50 of an inside door handle 46 (FIG. 3A) and a spindle 62 of an outside door handle 58 (FIG. 3B) respectively, wherein the receptacles are separated from one another as will be become apparent hereinafter.

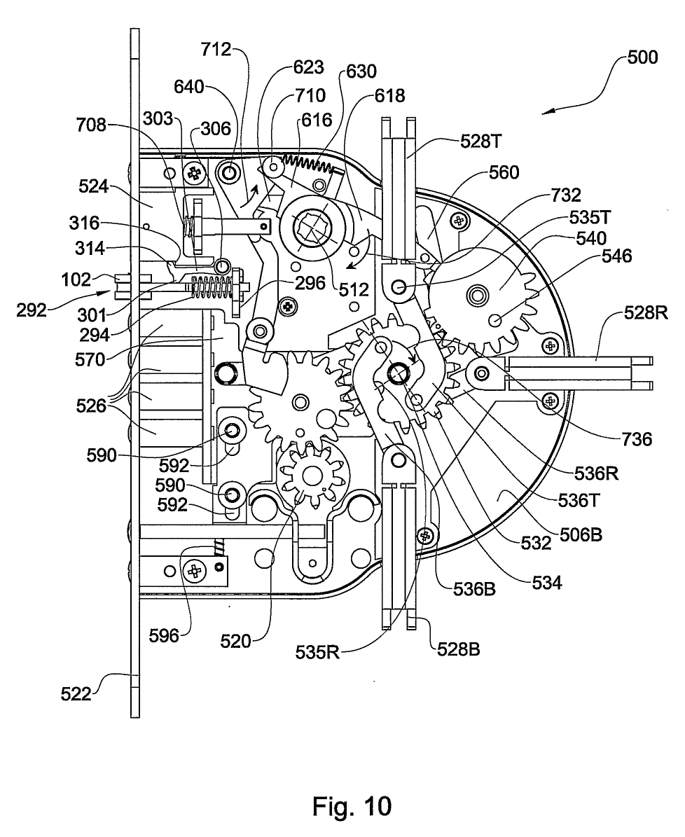

Furthermore, and typical with a mortise lock of this kind, the cylinder lock 502 represented in FIG. 10 by cog wheel 520, is fitted with a removable outside key (not shown) and a fixed inside knob. However, the inside knob may be replaceable by a removable key, as discussed hereinabove.

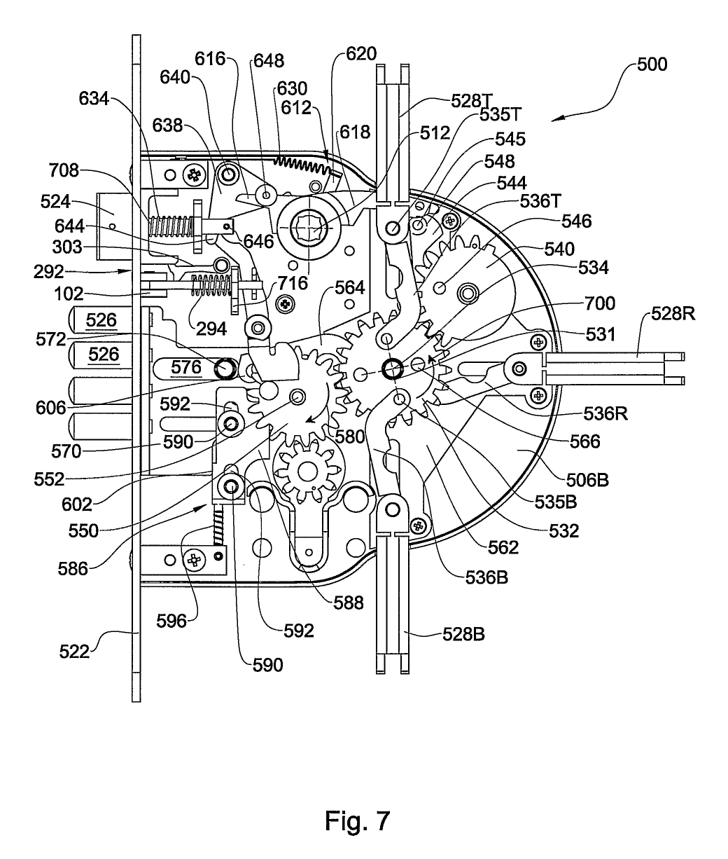

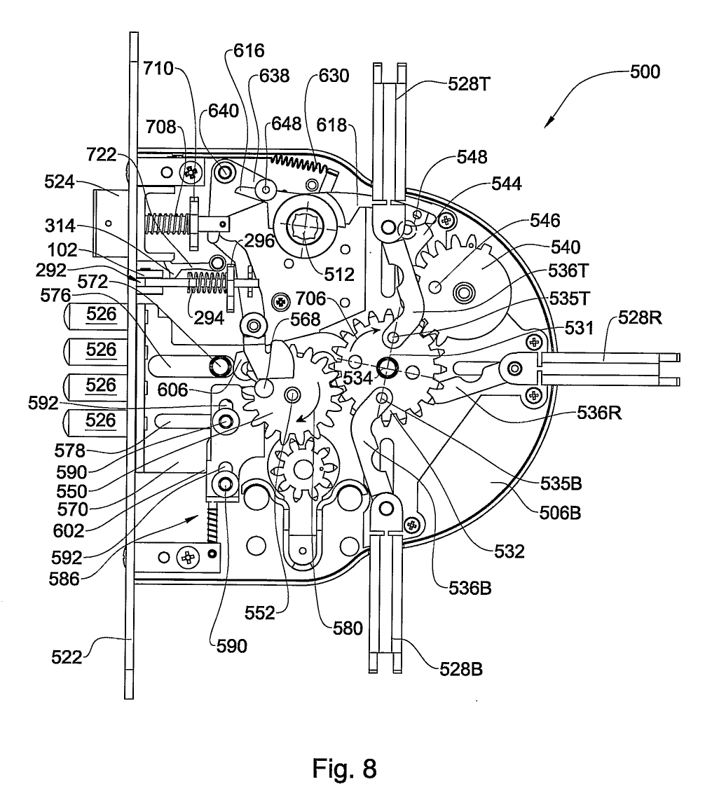

Furthermore, the mortise lock is formed with a front plate 522 slidingly accommodating locking latch 524 displaceable between a retracted position (FIGS. 10 to 12) and a projecting position (FIGS. 7 to 9). A plurality of face bolts 526 (4 in the present example) are also slidingly displaceable through the front plate 522 between a retracted position (FIGS. 10 to 12) and a projecting position (FIGS. 7 and 8).

The mortise lock 500 further comprises three secondary bolts namely a top bolt 528T, a bottom bolt 528B and a rear bolt designated at 528R. It is noticed that the locking latch 524 and the face bolts 526 are displaceable upon parallel axes being substantially horizontal and similarly the rear secondary bolt 528R is displaceable upon an axis parallel to said horizontal axis. According to a different embodiment (not shown) the rear bolt fixedly projects through the rear of the door. However, the secondary bolts 528T and 528B are displaceable upon a coaxially extending axis being substantially perpendicular to said first axis. The bolts 528T, 528R and 528B are restricted for axial displacement by means of grooves 561 formed in the plate 562 slidingly receiving pins 563.

As discussed hereinabove, the secondary bolts 528T, 528B and 528R are fitted for articulation via extension rods 82T, 82B and 94 (shown FIG. 4) to corresponding auxiliary locks (not shown) respectively, for locking engagement at the locking style of a door and a hinged style of a door, respectively. Alternatively, the secondary bolts merely activate locking rods projecting into the sashes.

As apparent from FIG. 5, the locking latch 524 and the face bolts 526 extend substantially symmetrically about the longitudinal axis of the front plate 522 whereby the lock is easily fitted within a “left side door” or a “right side door”.

A geared locking cog 532 is pivotally secured to the casing at 534 wherein each of the secondary bolts is articulated thereto by means of a pivot arm 536T, 536R and 536B, respectively, said pivot arms being pivotally secured at a proximal end thereof to the locking cog 532 (by pins 535T, 535B and 535R) and at a distal end thereof to the respective secondary bolt 528 (by pins 537T, 537B and 537R) The arrangement is such that pivot arms 536T and 536B are pivoted to the locking cog 532 about a line 531 extending through the center 534 of the locking cog 532. It is also noticed that whilst the pivot arms 536T and 536B extend above the locking cog 532, the pivot arm 536R extends below the locking cog 532 with a distal end (at 535R) of the pivot arm 536R pivoted to the locking cog 532 at a point generating a line with center pin 534 adapted to transverse the axis 531 at a substantially perpendicular relation.

The geared locking cog 532 is engaged by a semi geared secondary cog 540 whereby rotation of one cog entails corresponding angular displacement of the other cog wheel, the purpose of which will become apparent thereafter.

Pivotally articulated to the secondary cog 540 there is provided a pivot link 544 pivotally articulated at 546 to the secondary cog 540 and comprising a cam roller 548 slidingly displaceable within a cam groove 560 (FIGS. 5, 6, 9 and 10) either formed directly in the rear cover plate 506B or, as in the present example, formed in a cam plate 562 (This applies to the other directing grooves as well, e.g. grooves 561 etc.).

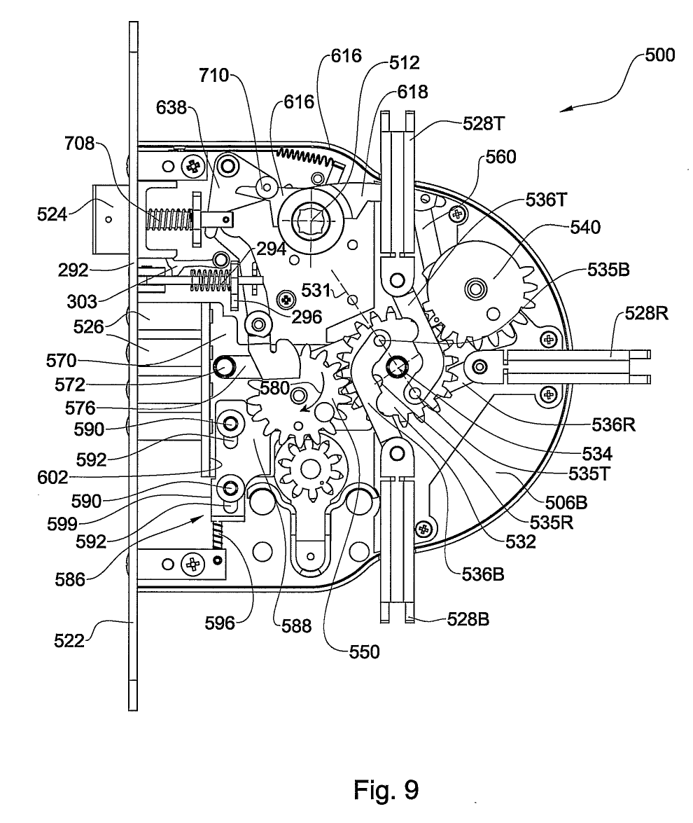

The geared locking cog 532 is also engaged to a locking gear 550 pivotally secured to the casing at 552 the arrangement being such that at an assembled position of the lock, in the presence of a cylinder lock, the locking gear 550 is engaged with a corresponding activating gear 520 of the cylinder lock 502 (FIGS. 9 to 11), whereby rotation of the cylinder lock entails a chain rotation of gears 550, 532 and 540, respectively, as will become apparent hereinafter.

Reverting now to the geared locking cog 532, it is apparent that a further pivot arm 564 is pivotally linked at 566 to the cog wheel 532 and at 568 to a locking plate 570 bearing the four face bolts 526.

The locking plate 570 is capable of displacing only about an axis parallel to said first axis (substantially horizontal) owing to a plurality of pins 552, 572 and 574 fixed to the casing and received within corresponding grooves 576 and 578. The arrangement is such that rotation of the locking gear 550 in the direction of arrow 580 entails projection of the face bolts 526 and rotation of the locking gear 550 in a direction opposite to that of arrow 580 entails retraction of the face bolts 526.

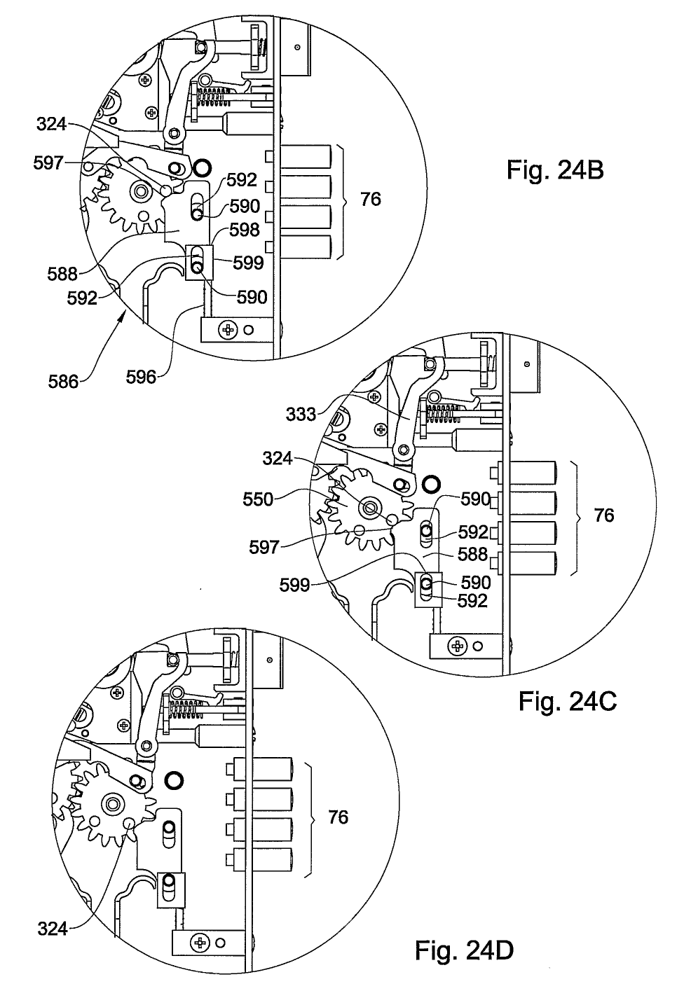

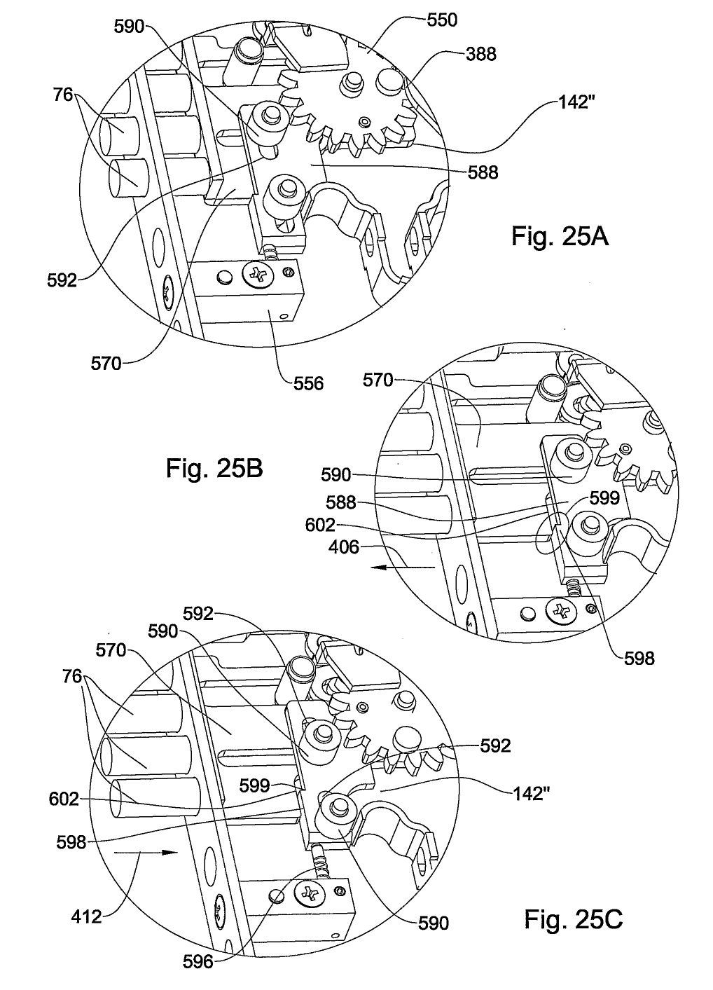

The mortise lock 500 is fitted with a dead bolt mechanism generally designated 586. With reference also to FIGS. 24 and 25, the dead bolt mechanism 586 comprises a locking piece 588 restricted for axial displacement about a second axis (substantially vertical) owing to two positioning pins 590 extending from the casing and slidingly received within a pair of grooves 592 formed in the locking piece. The locking piece 588 is normally biased in an upward direction owing to a coiled compression spring 596 and the locking piece 588 is thus displaceable between an upward, biased position as seen in FIGS. 7, 8, 25A and 25C and a downward, depressed position, as in FIGS. 9, 10, 11 and 25A. Locking piece 588 is formed with a shoulder 599 (best seen in FIG. 25) for abutting arresting a bottom shoulder 602 of locking plate 570.

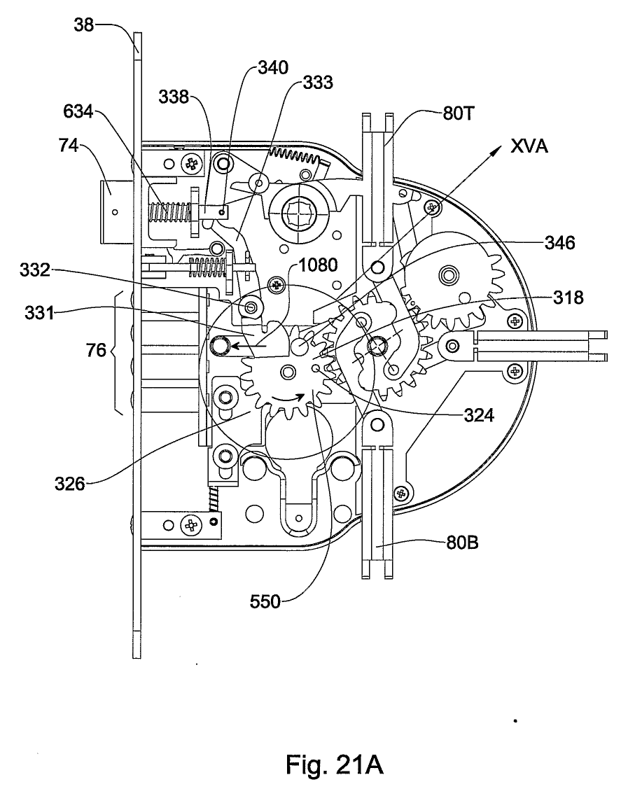

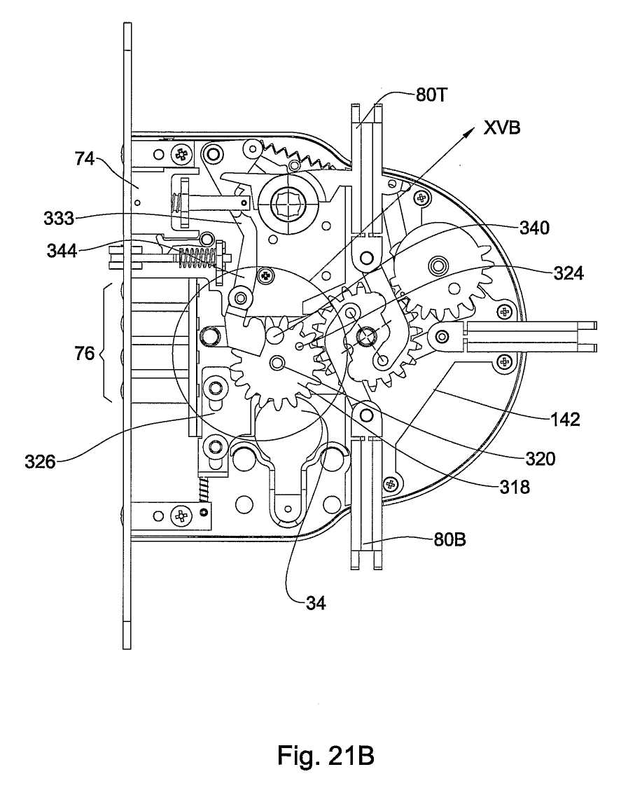

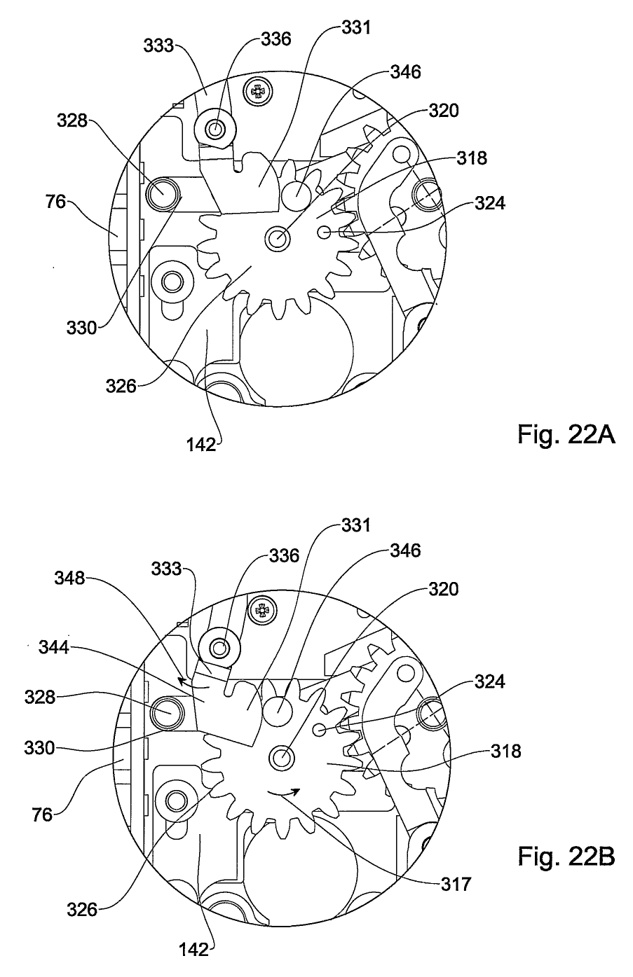

The arrangement is such that only when the locking piece 588 is in its downward position, the locking plate 570 is free to displace rearwards. This arrangement ensures that the face bolts 526 cannot be forced into an unlocking position. The locking piece 588 is displaced into its downward position, against the biasing effect of the coiled spring 596 by means of a dead-bolt pin 324 (FIGS. 21 and 22) positioned on the locking gear 550, which at the unlocking position bears against the slope 597 locking piece 588 and depresses it downwardly against the biasing effect of spring 596. However, upon unlocking, namely rotating the locking gear 550 in the direction of arrow 580, the dead-bolt pin 324 disengages from the locking piece 588, facilitating its upward displacement to thereby arrest the locking plate 570 as discussed hereinabove.

The handle assembly 612 comprises a locking latch activating arm 616 and a bolt activating arm 618, laterally projecting in opposite directions and integrated with the pivotally secured square receptacle 512. Coaxially extending behind there is provided a rear locking latch activator arm 620 which in turn is articulated with a square receptacle (not seen) for receiving a square spindle of the outside handle (not shown).

The arrangement is such that the bolt activating arm 618 bearingly engages against pivot link 544 through pin 545, which, as previously explained, is articulated to gear 540. When the inside handle 46 (not shown) is depressed, arm 618 causes a downward displacement of the link 544, resulting in counter-clockwise rotation of the gear 540. This, in turn, results in simultaneous rotation of locking gears 550 and 532, entailing retraction of the bolts 528B, 528T and 528R, facilitating opening of the door. During locking of the door, the arrangement of the top bolt 528T is such that axial displacement of the top bolt 528T in an outward direction (into a locked position) entails displacement of the bolt activating arm 618 in a counter clockwise direction for a purpose to become apparent hereinafter.

The handle assembly 612 is biased into a counter clockwise direction so as to retain a handle (not shown) at an essentially horizontal position, as known per se. This however takes place by two separate biasing members namely a coiled spring 630 associated with the rear locking latch activating arm 620 and a coiled spring 634 associated with the locking latch 524 and normally biasing it to project from the front plate 522. In turn, projection of the locking latch 524 entails pivotal displacement of a bell type crank 638 pivotally secured at 640 to the rear plate of the casing and fitted with an arm portion 644 bearing against a pin 646 of the locking latch 524, and formed at its opposite end with a roller pin 648 bearing against the locking latch activator arm 616.

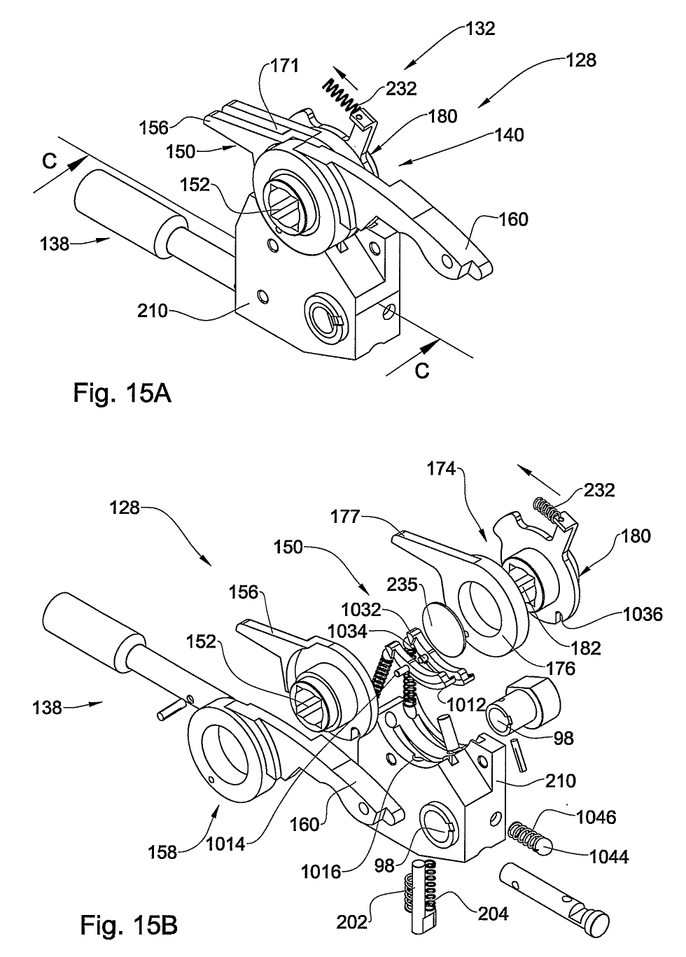

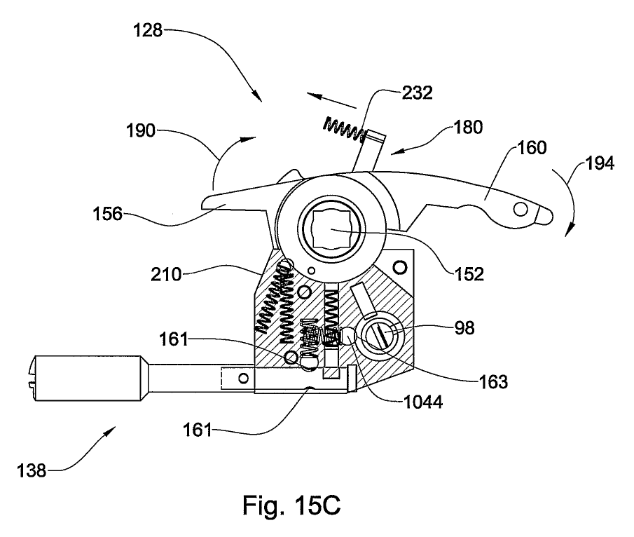

It is also appreciated that intermediate the front and rear handle activating members there is fitted a drill-proof steel separation plate 235 (FIG. 15B) thereby separating between the inside handle mechanism and the outside handle mechanism whereby vandalism and tempering from the outside do not affect the inside handle mechanism.

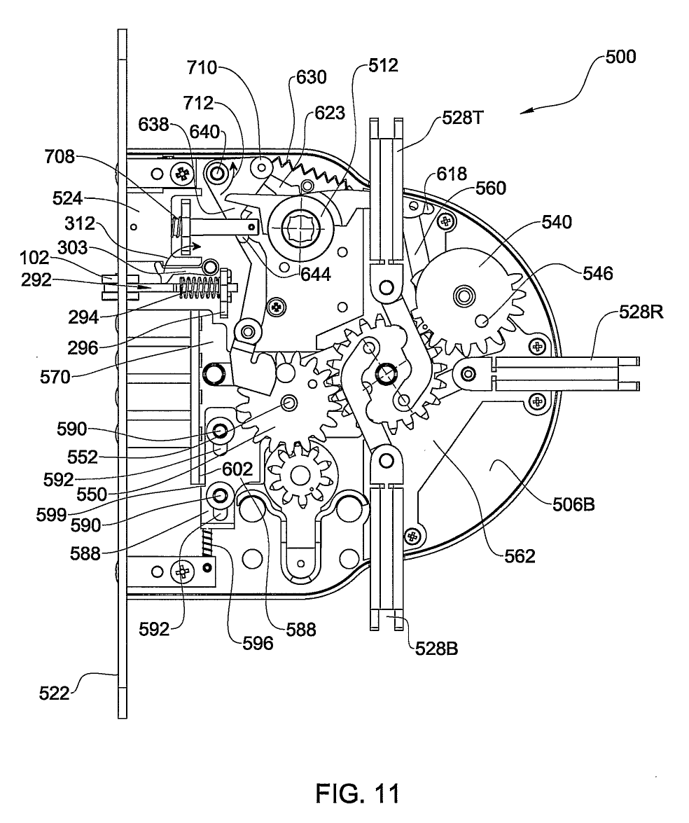

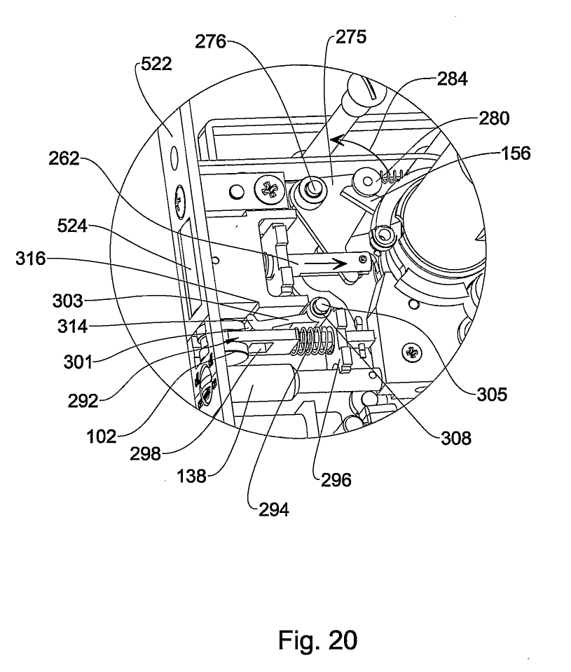

With Further reference also being made to FIG. 20, it is noticed that the lock comprises a locking latch sensor mechanism generally designated 292 whereby, as long as the door remains closed within the frame, depressing the inside handle 46 and releasing it, will entail displacement of the inside handle to its original position. In this position, the locking latch sensor mechanism 292 (FIG. 11) remains retracted with its follower wheels 102 bearing against a locking jam (not shown). However, depressing the inside handle 46 and opening the door, entails displacement of the locking latch sensor 292, owing to a biasing spring 294 bearing at a rear end thereof against a support plate 226. Locking latch sensor 292 comprises a recess 298 (FIG. 20) accommodating a projection 301 of a locking arm 303 which is pivotable about axis 306 and may be spring biased by coiled spring 308 in a downward direction, namely to bear against the arm of the locking latch sensor 292 in a manner facilitating smooth retraction and projection of the locking latch 524. The locking arm 303 is usually freely rotatable about the pivot point 305, achieving the downward movement of the locking arm 303 simply by gravity, thus eliminating the need for a biasing spring. However, upon opening the door whilst the inside handle 46 is depressed (position of FIG. 10) the locking latch sensor 292 is urged to project from the face plate 522, resulting in pivotal displacement of arm 303 upwardly, in the direction of arrow 312 (FIG. 11) whereby a shoulder 314 of arm 303 arrests a corresponding shoulder 316 of the locking latch 524 retaining the locking latch 524 at its retracted position and further retaining the inside handle at its depressed position thereby providing a visual indication that the door is unlatched (FIG. 10).

For better understanding how the lock in accordance with the present embodiment operates, attention is directed to FIG. 7 illustrated the mortise lock at a closed and locked position. In this position the locking latch 524 and the front bolts 526 project from the front plate 522 into locking engagement with corresponding openings of a locking sash (not shown) and similarly, the secondary bolts namely 528T, 528R and 528B are at their extended positions in locking engagement with a respective ceiling/wall/floor, respectively.

As can be seen in this drawing, the locking cog 532 is rotated all the way in a counterclockwise direction namely in direction of arrow 700 in FIG. 7 (this is facilitated by rotation of the cylinder lock as discussed hereinabove, which results in rotation of locking gear 550 in direction of arrow 580). In this position it is noticed that the line 531 extending between the pins 535T and 535B of the pivot centers of the pivot arms 536T and 536B respectively (and passing through the center 534 of the cog wheel 532) has exceeded the vertical line extending substantially between the secondary bolts 528T and 528B into a so-called over-locked position whereby axial force applied to the bolts 528T and 528B will not facilitate rotation of the cog 532 namely will not result in unlocking of the mortise lock.

As can further be noticed in FIG. 7, a similar arrangement exists between the pivot point 535R and 566 whereby at the locked position an attempt to apply vandalism force on the rear bolt 528R will not result in rotation of the cog wheel 532 into an open position.

Unlocking the mortise lock 500 takes place only upon a rotation of the cylinder lock (not shown) as in the position shown in FIG. 8. Upon partial rotation of the cylinder lock, the locking gear 550 rotates (about 30° in a direction opposite that of arrow 580) resulting in corresponding angular displacement of the locking cog 532 in the unlocking direction represented by arrow 706 in FIG. 8. As a result, the line extending between the pivot points 535T and 535B of arms 536T and 536B now passes the vertical lines extending between the bolts 528T and 528B such that further unlocking of the lock is facilitated, but only owing to rotation of the cylinder lock. Nevertheless, in this situation, the locking latch 524, the front bolts 526 and the secondary bolts 528T, 528R and 528B are still at their projecting, namely locking position.

FIG. 9 is a consecutive step of unlocking the mortise lock 500 in accordance with the present embodiment of the invention, wherein the locking gear 550 is rotated practically all the way through unlocking direction opposite that of arrow 580, resulting in corresponding rotation of wheel 532, though at an opposite direction. Such rotation results in retraction of the face bolts 526 and of the secondary bolts 528T, 528R and 528B. It is apparent that the bolts retain at their retracted position upon releasing the key of the cylinder lock. It is further apparent that the locking latch still projects and is still in its locked position.

Once the face bolts 526 and the secondary bolts 528T, 528R and 528B have been retracted (using the cylinder lock as explained hereinabove), retraction of the locking latch 524 may take place upon either further rotation of the cylinder lock by about another 30° or, as seen in FIG. 11, by depressing the outside handle (not shown) whereby the external locking latch activator arm 623 pivots to rotate the bell crank 638, resulting in retraction of the locking latch 524, as explained.

The locking latch can also be retracted using the inside handle (FIG. 10) wherein the locking latch activating arm 616 engages roller 710 of the bell crank 638 causing it to pivot in direction of arrow 712 resulting in turn in retraction of the locking latch 524.

It is appreciated, however, that the lock 500 in accordance with this embodiment has a built-in panic position, namely, also when the lock is completely locked, i.e. as in the position of FIG. 7 (namely, locking latch 524, face bolts 526 and secondary bolts 528T, 528R and 528B, are all at their projecting, locking position), the lock may be fully unlocked and opened simply by a one-stroke activation (depression) the inside handle (not shown) so as to retract all bolts and latches and facilitate instant opening of the lock. This takes place simultaneously by retracting the face bolts 526 and the secondary bolts 528T, 528R and 528B side by side with retraction of the locking latch 524.

Simultaneously, as explained above, the locking latch activating arm 616 engages roller 710 of the bell crank 638 causing it to pivot in direction of arrow 712 resulting in turn in retraction of the locking latch 524.

As mentioned hereinabove, these steps take place simultaneously whereby the mortise lock 500 is rapidly unlocked from the inside, in case of emergency. This procedure however, can not be performed using the outside handle, since the bolt activating arm 618 is permanently and securely disconnected from the outside handle.

The locking latch sensor mechanism generally designated at 292 operates to ensure that when the door is shut (i.e. displaced into its closed position) the locking latch 524 snaps into its projecting locking position.

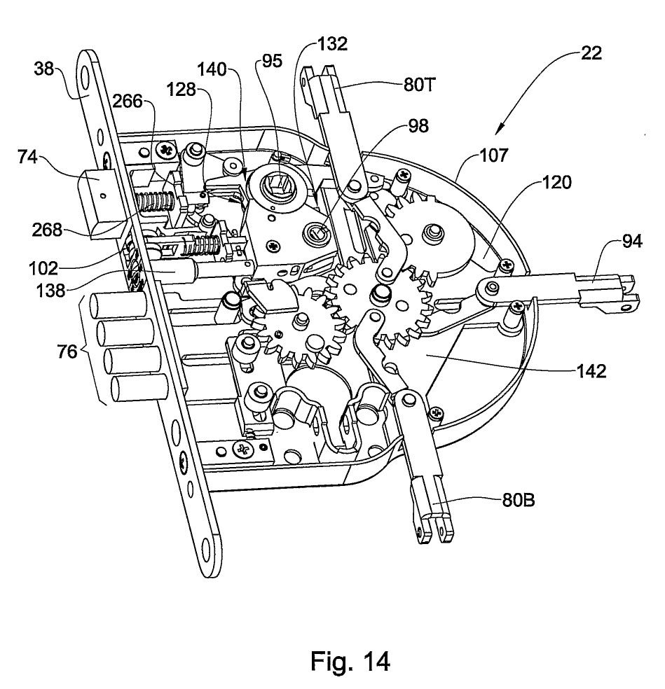

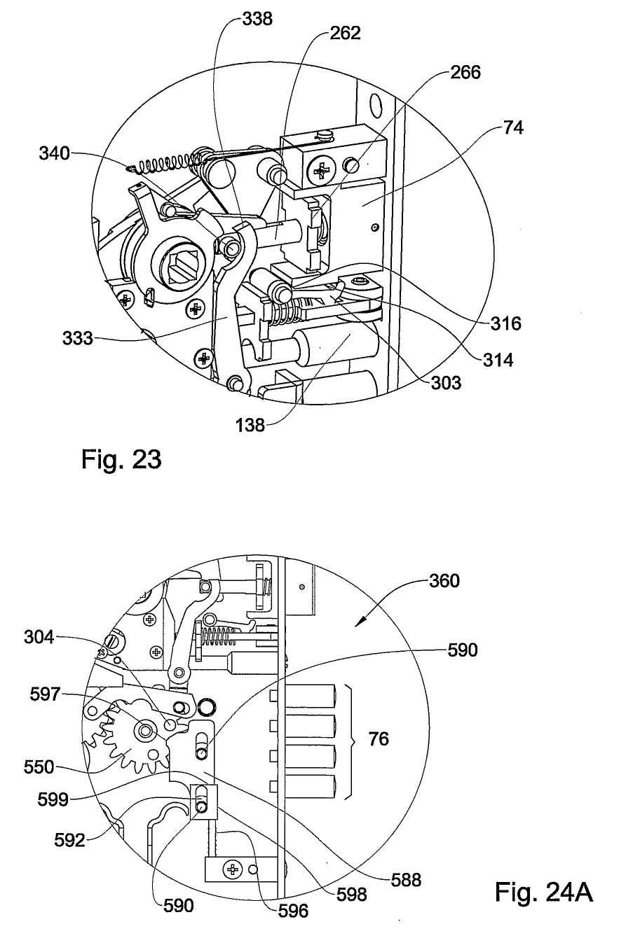

A second embodiment is depicted in FIGS. 13 to 25 in which FIG. 13 is a planar view of the lock in its fully locked position. This embodiment differs from the previous embodiment in that it further comprises a panic selector 138 and a handle selector coupler 98 as seen in FIG. 14 and in particular with reference being made to FIGS. 15 to 18.

Turning now to FIG. 13, the mortise lock 22 is illustrated from its inside, at its locked position, namely with locking latch 74 and face bolts 76 projecting through the face plate 38 and with the top and bottom bolts 80T and 80B at their extended, locked position. Further noticed in this figure, is a square receptacle 95 geometrically receiving the inside square spindle 50 (not shown), a handle selector coupler 98 fitted for engagement with handle selector actuator 54 (FIGS. 1 and 3A). Further noticed in FIG. 13, the inside plate 105 of the lock 22 is formed with several grooves, namely grooves 106 being substantially parallel to axial displacement of the face bolts 76 and extending along a first axis of the lock which slidingly receives sliding pins 108, to be discussed hereinafter, however, for the sake of ensuring displacement of the face bolts 76 and an associated locking plate (not shown in this figure) along said first axis only. It is further noticed that the rear static bolt 94 is secured to the case 107 of the lock and is also secured to the inside plate 105 (and the outside plate too, though not seen in this figure).

In FIG. 14, the inside cover plate has been removed, visualizing the outside plate 120 secured to the case 107 and the front panel 38. It is here noticed that locking latch 74 has a substantially rectangular cross section thus making it difficult, if not impossible, to manipulate by prying the latch 74 open with a credit card, etc. This applies also to locking latch 524 of the previous embodiment.

The lock 22 comprises a locking mechanism generally designated 128 comprising in turn a handle assembly 132 fitted with a handle selector 98 and a panic selector 138 as discussed hereinafter and further, with a handle selector mechanism generally designated 140 also discussed hereinafter

Handle assembly 132 seen in FIG. 15A comprises a handle selector mechanism 140 which as can best be seen in FIG. 15B comprises a square receptacle 152 for fit engagement with the corresponding inside square spindle 50 (see FIG. 3A) for angular engagement therebetween. A locking latch activating arm 156 laterally projects as will be discussed hereinafter. Coaxially mounted on the inside locking latch activator 150 there is a bolt activator formed with a bolt activating arm 160 and being selectively engageable with the inside locking latch activator 150 by the panic selector 138 as will be explained hereinafter.

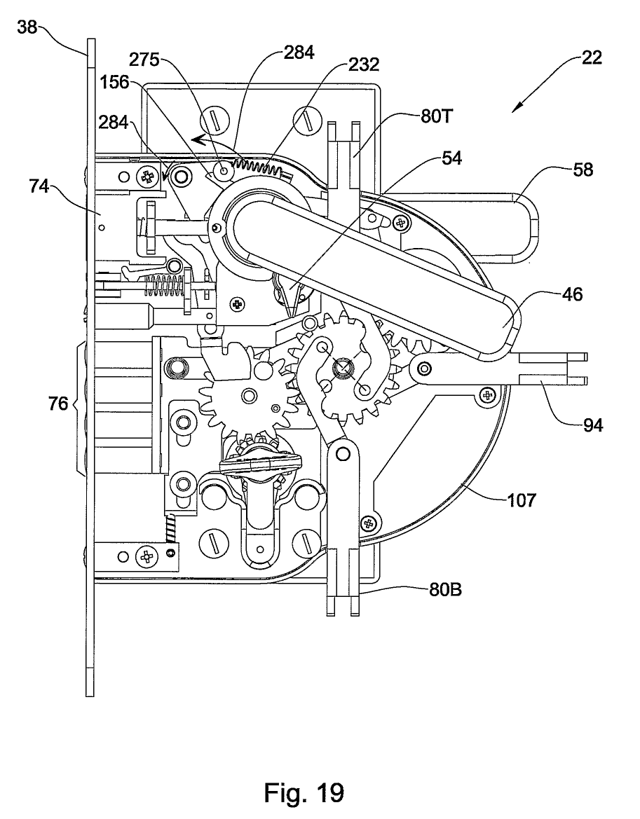

The handle selector mechanism 140 also comprises an outside locking latch activator 174 formed with a locking latch activator arm 177 and being selectively engaged with an outside handle coupler 180, fitted with a square receptacle 182 for receiving square spindle 62 of the outside handle 58 (FIG. 2) and selectively engageable therewith by means of handle selector knob 99 (FIG. 19) coupled in turn with actuator 98 as will be explained in more detail hereinafter.

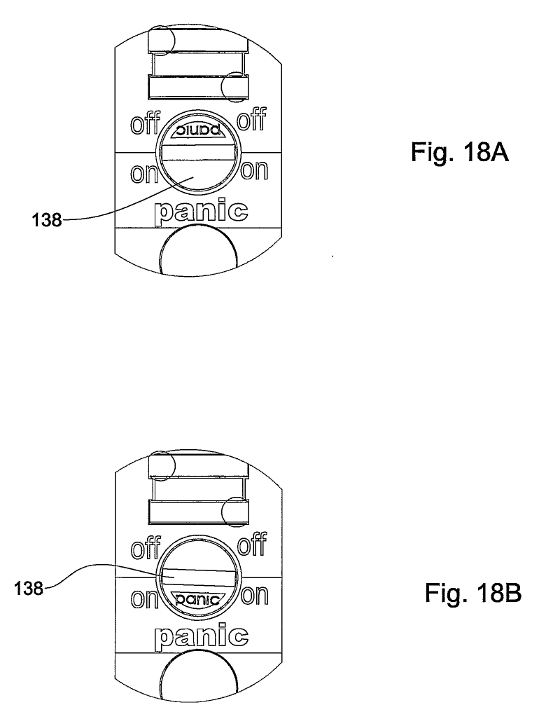

As already mentioned, the inside square spindle 50 is rotatably engaged with the square receptacle 152 of the inside locking latch activator 150 and at the normal course of operation, e.g. when the panic selector 138 is at its disengaged position referred to as an “off” position (FIG. 18A) is disengaged from the bolt activator 158 whereby depressing the inside handle 46 (FIGS. 1 and 2) entails angular displacement of the inside locking latch activator arm 156 in the direction of arrow 190 (FIG. 15C). However, upon engaging the panic selector 138 into the panic position (referred to as “on” position as in FIG. 18B) the bolt activator 158 rotatably engages with the inside locking latch activator 150 whereby depressing the inside handle will entail corresponding angular displacement also of the bolt activator arm 160 as represented by arrow 194 (FIG. 15C).

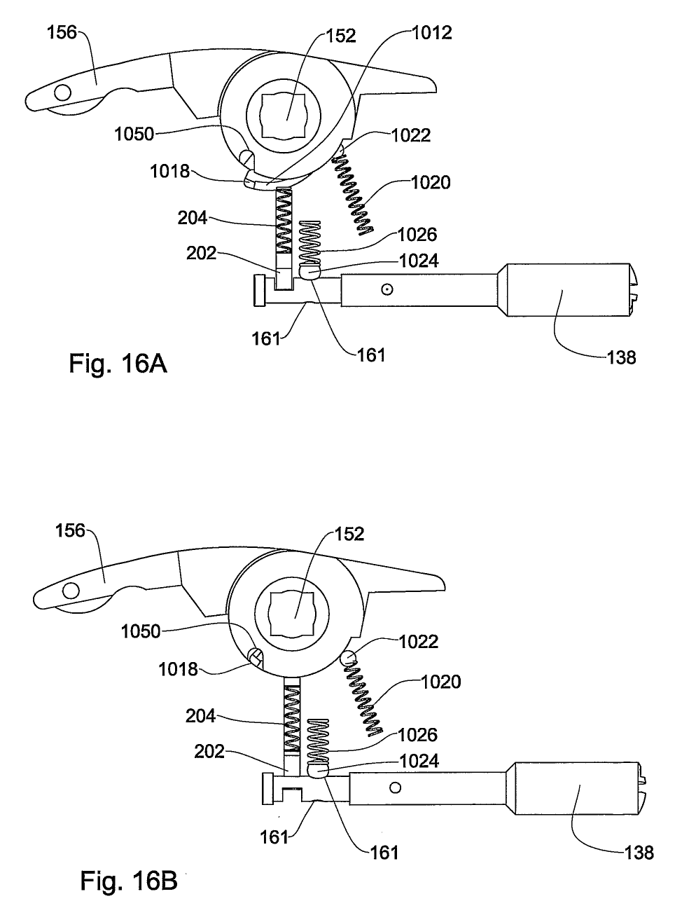

With reference to FIGS. 16A and 16B, engagement between the inside locking latch activator 150 and bolt activator 158 takes place by an L-like shaped plunger 202 normally downwardly biased by means of a coiled spring 204. A banana shaped member 1012 is hinged to the housing 210 by a pin 1014 positioned in indent 1016. As can further be seen, best in FIGS. 16A and 16B, the banana shaped member 1012 is normally biased by spring 1020 and ball 1022 such that the L-shaped tip 1018 of the member 1012 protrudes from the latch activator 156.

Upon rotation of the panic selector 138 into its panic position (namely “on” position as in FIG. 18B) the L-like plunger 202 axially displaces upwardly, pressing on the side of the banana shaped member 1012 against the biasing spring 1020 and ball 1022. This results in the L-shaped tip 1018 entering the slot 1050, whereby the inside locking latch activator 150 becomes rotatably engaged with the bolt activator 158 such that depressing the inside handle 46 (not shown) entails corresponding angular displacement of the inside locking latch activator arm 156 and the already engaged arm 160 of the bolt activator 158 in the direction of arrows 190 and 194, respectively. A ball 1024 is downwardly biased by spring 1026 and is adapted to fit into either one of recess 161 in order to keep the selector 138 from spontaneous switching from one position to the other.

It is further noticed that on one hand at the non-panic position the bolt activator 158 is rotatably disengaged from the inside locking latch activator 150, and on the other hand, it is rotatably fixed with respect to the handle selector mechanism housing 210 i.e., the bolt activator 158 and its arm 160 are angularly fixed for a purpose to become apparent hereinafter.

The panic position is desired to permit a person at an inside of the door to unlock the locking latch 74 as well as face bolts 76 and top and bottom bolts 80T and 80B respectively, upon an emergency, by a single depression of the inside handle 46, this being regardless of the situation of the lock cylinder 34.

Whilst the panic selector 138 is illustrated in the figures on the face plate 38, it may be positioned also on an inside face of the door, though not common practice in the art.

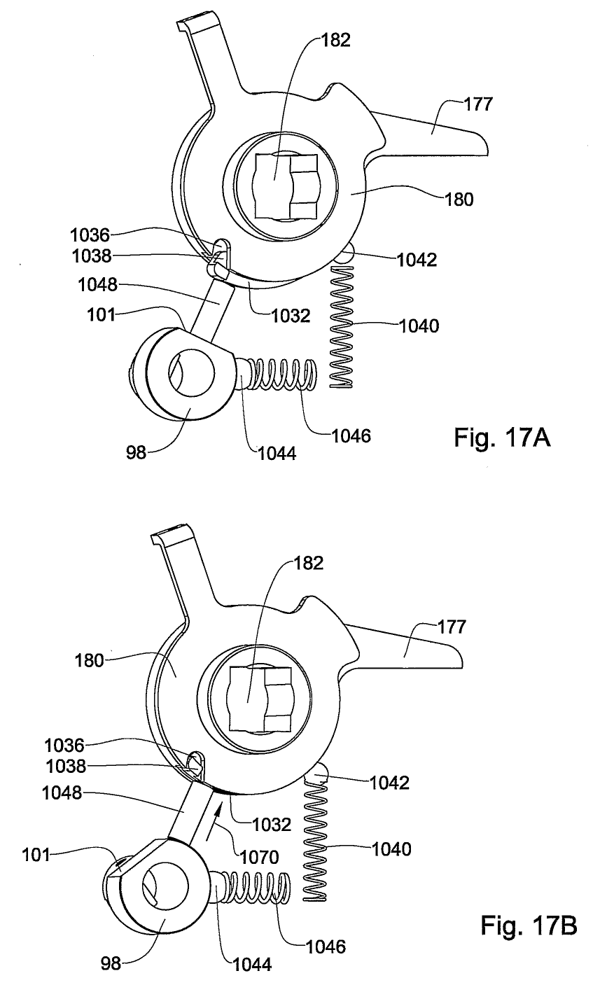

Turning now also to FIGS. 17A and 17B, there is illustrated a similar mechanism for the outside handle coupler 180. The coupler 180 is formed with the square receptacle 182 for fixedly engaging with outside square spindle 62 of outside handle 58 (not shown) which at the normal course of operation is biased by a spring 232 (FIGS. 15A-15C) to retain the outside handle at its undepressed position. In the normal position of the door, the outside handle is freely depressible, though disengaged from any operable mechanism thereby no actual result will occur upon depressing the handle. It is further noticed that the inside spindle receptacle 152 (FIGS. 15A to 15C) is separated from the outside spindle receptacle 182 by means of a drill-proof steel separation plate 235 (FIG. 15B) thereby there is no mutual effect between the inside handle mechanism and the outside handle mechanism and whereby even in the event of vandalism and removing of the outside handle, tempering with of the inside mechanism is not possible owing to said plate 235.

A banana shaped member 1032 is hinged to the housing 210 by a pin 1034 positioned in indent 1036. As can further be seen, best in FIGS. 17A and 17B, the banana shaped member 1032 is normally biased by spring 1040 and ball 1042 such that the L-shaped tip of the member 1038 protrudes from the coupler 180. A plunger 1048 bears against a surface 101 of the selector 98.

Upon rotation of the selector 98 the plunger 1048 axially displaces upwardly, in the direction of arrow 1070 pressing on the side of the banana shaped member 1032 against the biasing effect of spring 1040 and ball 1042. This results in the L-shaped tip 1038 entering the slot 1036, whereby the arm 177 becomes rotatably engaged with the handle coupler 180 such that depressing the outside handle 58 (not shown) entails corresponding angular displacement of inside locking arm 177 and the already engaged arm 180 of the bolt activator 182 in the direction of arrows 190 and 194, respectively (FIG. 15C). The ball 1044 is laterally biased by spring 1046 and is adapted to fit into either one of recess (not shown) in order to keep the selector 98 from spontaneous switching from one position to the other.

Referring now to FIGS. 21 to 23, further reference is made to the locking latch mechanism of the lock 22. The locking gear 550 is fitted with a knob 346, adapted to press against a lower end 331 of a latch lever, freely pivotable about a pivot point 332. When the locking gear 550 is turned using cylinder key the knob 346 pushes the lower end 331 in direction of arrow 1080, resulting in displacement of the hook 338 in direction opposite arrow 1080. This movement of the hook works against the effect of the biasing spring 634 to facilitate retraction of the locking latch 524.

However, as mentioned hereinbefore, the outside handle mechanism and the inside handle mechanism are at all times disengaged, namely depressing the outside handle when the handle selector is engaged will result in retracting the locking latch by the separable/independent outside locking latch activator arm 177, however, without engagement with the inside locking latch activator 150 and correspondingly without engagement with the bolt activator 158.

In the annexed table, there are illustrated different positions of the panic selector and hand selector and their effect on operating the lock in accordance with the invention by the inside handle, the outside handle and the key.

In the table, the terms ‘ON’ and ‘OFF’ are used to denote the engaged/activated and disengaged/deactivated positions of the panic selector and the handle selector, respectively.

Furthermore, the term ‘bolts’ denotes the face bolts of the lock and any other auxiliary bolts, i.e. top and bottom bolts, as described hereinabove.

Panic selector

| | | | |
|---|---|---|---|
| On | On | Off | Off |

Handle selector

| | | On | Off | On | Off |
|---|---|---|---|---|---|
| Inside handle | locking latch | ✓ | ✓ | ✓ | ✓ |
| | Bolts | ✓ | ✓ | — | — |
| Outside handle | locking latch | ✓ | — | ✓ | — |
| | Bolts | — | — | — | — |
| key | locking latch | ✓ | ✓ | ✓ | ✓ |
| | Bolts | ✓ | ✓ | ✓ | ✓ |

Whilst some embodiments have been described and illustrated with reference to some drawings, the artisan will appreciate that many variations are possible which do not depart from the general scope of the invention, mutatis, mutandis.

1. A mortise lock comprising a mortise lock case housing, a locking mechanism, a locking latch and one or more bolts displaceable between a locked position and an unlocked position; the locking mechanism fittable with a lock cylinder, a handle assembly comprising an inside locking latch activator articulated with the locking latch and the bolts and an independent outside locking latch activator articulated only with the locking latch; a locking latch sensor for selectively arresting the locking latch, and a deadbolt mechanism for locking the bolts at their extended, locked position.

2. A mortise lock according to claim 1, wherein the lock is a multi-functional lock fitted with a panic selector for selectively engaging the inside handle with the bolts regardless of whether or not the bolts are locked by the lock cylinder, and a handle selector for selectively engaging the outside handle with locking latch.

3. A mortise lock according to claim 2, wherein the handle assembly comprises a handle selector mechanism comprising in turn an inside locking latch activator operable by the inside handle, and a bolt activator selectively engageable with said inside locking latch activator by the panic selector, and a separable outside locking latch activator selectively engageable with the outside handle by a handle selector knob.

4. A mortise lock according to claim 1, wherein the inside locking latch activator and the outside locking latch activator are coaxial and are separated from one another by a security plate.

5. A mortise lock according to claim 2, wherein the outside locking latch activator is selectively engageable with the outside handle via a coupling member fixed with the outside handle.

6. A mortise lock according to claim 5, wherein the coupling member is biased to retain the outside handle at its closed position.

7. A mortise lock according to claim 3, wherein when the outside locking latch activator is disengaged from the outside handle it is lockingly engaged with a casing of the handle selector mechanism.

8. A mortise lock according to claim 3, wherein when the inside locking latch activator is disengaged from the bolt activator, it is lockingly engaged with a casing of the handle selector mechanism.

9. A mortise lock according to claim 2, wherein the panic selector and the handle selector are displaceable between discrete positions.

10. A mortise lock according to claim 1, wherein the locking latch sensor operates in conjunction with a lock jamb supporting a door fitted with the lock, for engaging the locking latch and retaining it at its retracted position in case the door is open; however upon closing the door the locking latch will return to its locked, projecting position.

11. A mortise lock according to claim 10, wherein the inside handle activator is articulated with the locking latch by a bell crank, such that once the inside handle is depressed it will remain at its depressed position if the door is open, and the inside handle will return to its non depressed position upon closing the door.

12. A mortise lock according to claim 1, wherein the locking latch sensor comprises a spring biased plunger projecting from the front plate of the lock and formed with a cam surface followed by a spring biased locking arm designed to engage with the locking latch and arrest it at its retracted position when said plunger projects from the front panel.

13. A mortise lock according to claim 1, wherein the bolts comprise one or more face bolts projecting from the front plate of the mortise lock case housing and being displaceable along a first axis; and one or more secondary bolts projecting from the case housing and being restricted for displaceable about a second axis substantially perpendicular to said first axis.

14. A mortise lock according to claim 13, wherein the face bolts are articulated to a locking plate displaceable between a respective locked and an unlocked position, either by a key-operated lock cylinder or by the inside handle, said locking plate being restricted into axial displaceable in a plane along the first axis, and where the secondary bolts are each articulated to the locking plate by a link converting linear motion from said first axis into said second axis.

15. A mortise lock according to claim 1, wherein the locking latch has a rectangular cross-section.

16. A mortise lock according to claim 2, wherein the inside handle is permanently engaged with the locking latch and the outside handle is permanently disengaged from the one or more bolts; and wherein when the panic selector is activated the inside handle engages with the bolts and when the handle selector is activated the outside handle is engaged with the locking latch.

17. A mortise lock according to claim 1, where the locking latch and optional one or more face bolts projecting from the front plate of the mortise lock case housing, symmetrically extend at a locking stile of a door for fitting within left sided or right sided doors.

18. A mortise lock according to claim 1, further comprising a static bolt fixedly extending from the lock case housing through a hinge stile of a door for engagement with a corresponding aperture formed at a door jamb.

19. A mortise lock according to claim 3, wherein a locking plate is articulated by a crank lever to the bolt activator, whereby depressing the inside handle, when the panic selector is activated to engage the inside handle with bolts, result in axial displacement of the locking plate about said first axis.

20. A mortise lock according to claim 14, wherein the locking plate is fitted with a locking gear engaged to an actuating gear of the key-operated lock cylinder, and further there is provided a crank link coupling said locking gear with the locking plate, whereby rotating the lock cylinder entails axial displacement of the locking plate about said first axis.

21. A mortise lock according to claim 1, wherein rotating the lock cylinder beyond 360° entails retraction of the locking latch by a pivot lever articulated at one end with the locking latch and at an opposed end it is formed with a follower arm for engagement with a cam projection formed on the locking gear.

22. A mortise lock according to claim 20, wherein the crank link is pivotally articulated to the locking plate, with a degree of freedom along the first axis, such that the face bolts do not retract beyond the front plate even when the lock cylinder is rotated more then 360°.

23. A mortise lock according to claim 14, wherein the locking plate is restricted for axial displacement about said first axis by one or more axial grooves formed in the lock case, and corresponding follower projections formed on the locking plate.

24. A mortise lock according to claim 14, wherein the deadbolt mechanism comprises a locking piece restricted for axial displacement about the second axis between an upward, biased position and a downward position; the locking plate is formed with an abutting shoulder for abutting against a corresponding shoulder of the locking piece such as to prevent displacement of the locking plate, namely to prevent retraction of the face bolts.

25. A mortise lock according to claim 24, wherein the locking piece is displaced downward by a connecting lever pivotally coupled to a locking cog.

26. A mortise lock according to claim 25, wherein the locking piece is displaced by a cam of a cylinder engaging gear wheel which in turn is engaged with the lock cylinder.

27. A mortise lock comprising a mortise lock casing accommodating a handle assembly comprising a panic selector and a handle selector for selectively engaging an inside handle and an outside handle and controlling their function, a locking latch articulated to the handle assembly and to a locking latch sensor, one or more bolts manipulable by a locking plate and being displaceable between an open position and a locked position, and a deadbolt mechanism for locking face bolts extending from said locking plate at their extended, locked position.

28. A mortise lock according to claim 14, wherein the deadbolt mechanism comprises a locking block fixed within the mortise lock case, a bridge member fixedly attached to the face bolts and being articulated to the locking plate with limited degree of freedom along the first axis, a locking piece articulated to the locking plate and having limited degree of freedom along the second axis; said locking piece being articulated to the bridge member by a motion converting mechanism such that axial displacement of the bridge member about said first axis entails corresponding axial displacement of the locking piece about said second axis, whereby when the face bolts are at their extended, locked position, the locking piece is lockingly engaged with the locking block, and where retracting the face bolts entails disengagement of the locking piece from the locking block.

29. A mortise lock according to claim 28, wherein the motion converting mechanism is in the form of an engagement member projecting from one of the bridge member and the locking piece, and an inclined slot formed in the other of said bridge member and the locking piece and slidingly receiving said engagement member.

30. A mortise lock according to claim 28, wherein the locking block is formed with a gliding surface and an arresting shoulder, and the locking piece is formed with a sliding portion formed with a locking edge, wherein when at the locked position of the face bolts the locking edge is arrested by the arresting shoulder; and during displacement of the face bolts between a retracted, open position, and an extended, locked position, the sliding portion smoothly slides over said gliding surface.

31. A mortise lock according to claim 28, wherein the locking piece is articulated to the locking plate by an engagement member projecting from one of the locking plate and the locking piece, and a slot extending along said second axis, formed in the other of said locking plate and the locking piece and slidingly receiving said engagement member.

32. A mortise lock according to claim 28, wherein the bridge member is articulated to the locking plate by an engagement member projecting from one of the locking plate and the bridge member, and a slot extending along said first axis, formed in the other of said locking plate and the bridge member and slidingly receiving said engagement member.
